(19) United States
(12) Patent Application Publication
(10) Pub. No.: US 2013/0127861 A1
(43) Pub. Date: May 23, 2013

(54) DISPLAY APPARATUSES AND METHODS FOR SIMULATING AN AUTOSTEREOSCOPIC DISPLAY DEVICE

(71) Applicant: Jacques Gollier, Painted Post, NY (US)

(72) Inventor: Jacques Gollier, Painted Post, NY (US)

(21) Appl. No.: 13/299,961

(22) Filed: Nov. 18, 2011

(51) Int. Cl. G06T 15/50; G06T 15/00

(52) U.S. Cl. 345/426; 345/419

(57) ABSTRACT

Display apparatuses and methods for simulating an autostereoscopic display device to reduce development costs and time for such autostereoscopic display devices are disclosed herein. In one embodiment, a display device includes a stereoscopic display device capable of displaying a three-dimensional image that is inherently substantially free from image artifacts, and an image generation unit. The image generation unit provides data representing at least one view pair to the stereoscopic display. The at least one view pair includes a right eye image for viewing on the stereoscopic display by a right eye of an observer, and a left eye image for viewing on the stereoscopic display by a left eye of the observer. The at least one view pair is based at least in part on autostereoscopic device parameters such that the stereoscopic display displays the at least one view pair with the autostereoscopic device parameters.

### BACKGROUND

1. Field

The present specification generally relates to autostereoscopic display devices and, more particularly, apparatuses and methods for simulating an autostereoscopic display device.

2. Technical Background

An autostereoscopic display is a device that produces a three-dimensional image without the use of special glasses, such as active shutter glasses or passive glasses. Autostereoscopic display devices may produce many views of an image such that an observer sees a pair of views that create a three-dimensional image impression. One particular type of autostereoscopic display device uses a lenticular lens assembly comprising an array of cylindrical lenses that are configured to separate and direct light emitted by adjacent pixel columns to create the different views that may be visible to an observer located in an observer plane.

The generation of a satisfactory three-dimensional image depends on a balance of many hardware and software considerations, including, but not limited to, lenticular lens design and arrangement, pixel pitch, illumination technique, image generation algorithms, and the like. Autostereoscopic device parameters associated with these hardware and software considerations should be evaluated when designing autostereoscopic display devices. However, it may be very costly and time consuming to build an autostereoscopic display device each time a new set of autostereoscopic device parameters need to be evaluated. The requirement that actual devices be built for testing and evaluation purposes may slow down the development process and prevent new autostereoscopic display devices from reaching the market with reasonable price points.

Accordingly, a need exists for alternative devices and methods for evaluating autostereoscopic device parameters by simulation of an autostereoscopic device to reduce development costs and time.

### SUMMARY

The embodiments disclosed herein relate to display apparatuses and methods for simulating an autostereoscopic display device to reduce development costs and time needed to bring autostereoscopic display devices to market.

According to one embodiment, a display apparatus for simulating an autostereoscopic display device to reduce device development cost and time is disclosed. The display device includes a stereoscopic display device capable of displaying a three-dimensional image that is inherently substantially free from image artifacts, and an image generation unit. The image generation unit provides data representing at least one view pair to the stereoscopic display. The at least one view pair includes a right eye image for viewing on the stereoscopic display by a right eye of an observer, and a left eye image for viewing on the stereoscopic display by a left eye of the observer. The at least one view pair is based at least in part on autostereoscopic device parameters such that the stereoscopic display displays the at least one view pair with the autostereoscopic device parameters.

According to another embodiment, a method of simulating an autostereoscopic display device for reducing device development cost and time is disclosed. The method includes generating or receiving a plurality of views of an image, and determining an angular position θk(t) of an observer over time (t) based on a location of the observer. The method further includes generating a view pair including a right eye image and a left eye image by applying an influence function to both a first view of the plurality of views and a second view of the plurality of views. The influence function is based at least in part on autostereoscopic device parameters and the angular position θk(t) of the observer. Data representing the view pair is provided to and displayed by a stereoscopic display that is inherently substantially free from image-artifacts.

According to yet another embodiment, a display apparatus for simulating an autostereoscopic display device to reduce device development cost time is disclosed. The display apparatus includes a stereoscopic display and an image-generation unit. The stereoscopic display device is capable of displaying a three-dimensional image that is inherently substantially free from image artifacts. The image-generation unit includes a processor, a signal output module, and a memory component. The memory component stores computer-executable instructions that, when executed by the processor, causes the image-generation unit to generate or receive a plurality of views of an image and determine an angular position θk(t) of an observer over time (t) based on a location of the observer. The computer-executable instructions further cause the image-generation unit to generate a view pair including a right eye image and a left eye image by applying an influence function to both a first view of the plurality of views and a second view of the plurality of views. The influence is function based at least in part on autostereoscopic device parameters and the angular position θk(t) of the observer. Data representing the view pair is provided to the stereoscopic display by the image-generation unit via the signal output module such that the stereoscopic display displays the view pair.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a top partial view of a display panel, lenticular lens assembly, and an observation plane of an exemplary autostereoscopic display device;

FIG. 2 schematically depicts a partial front view of an illumination device, a display panel, and a lenticular lens assembly of an exemplary autostereoscopic display device;

FIG. 3 schematically depicts a top partial view of a display panel, lenticular lens assembly, and observation plane of an exemplary multi-view autostereoscopic display device;

FIG. 4 schematically depicts a display apparatus comprising an image-generation unit and a stereoscopic display device according to one or more embodiments described and illustrated herein;

FIG. 5 schematically depicts components of an image-generation unit according to one or more embodiments described and illustrated herein.

FIG. 6 schematically depicts a ray tracing model simulation according to one or more embodiments described and illustrated herein; and

FIG. 7 schematically depicts an observer viewing a stereoscopic display device from multiple angular positions θk(t) according to one or more embodiments described and illustrated herein.

### DETAILED DESCRIPTION

Reference will now be made in detail to embodiments of display apparatuses and methods, examples of which are depicted in the attached drawings. Whenever possible, the same reference numerals will be used throughout the drawings to refer to the same or like parts. Embodiments of the present disclosure are generally directed to display apparatuses and methods that enable simulation of an autostereoscopic image on a stereoscopic display device. As an example and not a limitation, designers of an autostereoscopic display device may utilize embodiments of the present disclosure to test autostereoscopic device parameters of an autostereoscopic display that is under development to quickly determine the impact of the parameters on how the autostereoscopic images will be perceived. As used herein, the term “autostereoscopic display device” means a multi-view three-dimensional display device (e.g., a television, a hand held device, and the like) that does not require a user to wear or otherwise use a personal viewing device, such as active or passive glasses. Further, as used herein, the term “stereoscopic display device” means a three-dimensional display device that either requires users to wear or otherwise use a personal viewing device, or provides for a three-dimensional image that is inherently substantially free from autostereoscopic image artifacts regardless of whether or not personal viewing devices are needed to view the three-dimensional image.

As described in more detail below, embodiments enable a user to input autostereoscopic device parameters into an image-generation unit that outputs to a stereoscopic display device an image pair comprising two of many views created by the image-generation unit. In this manner, a user may test many autostereoscopic device parameters for many different locations of an observer on a stereoscopic display device without the need for building an actual autostereoscopic display device.

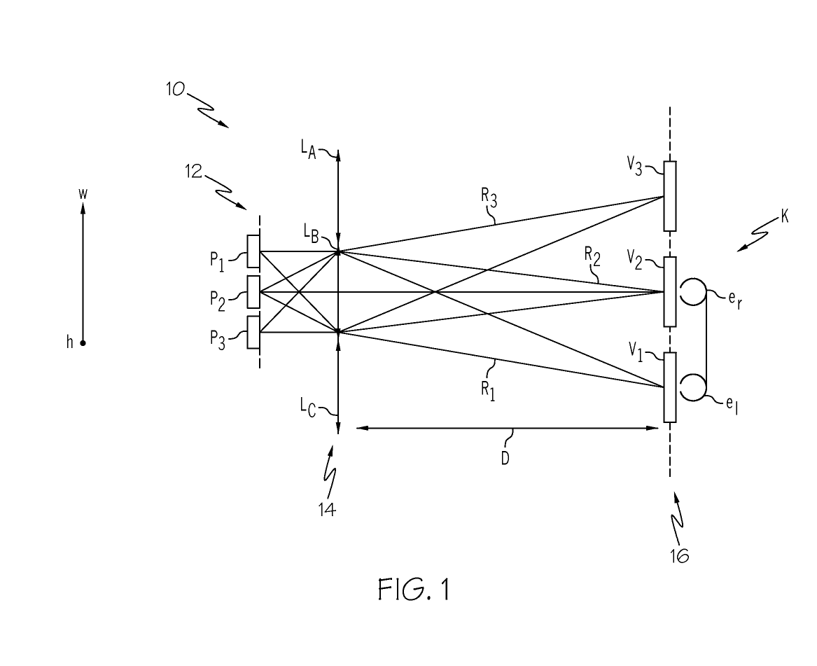

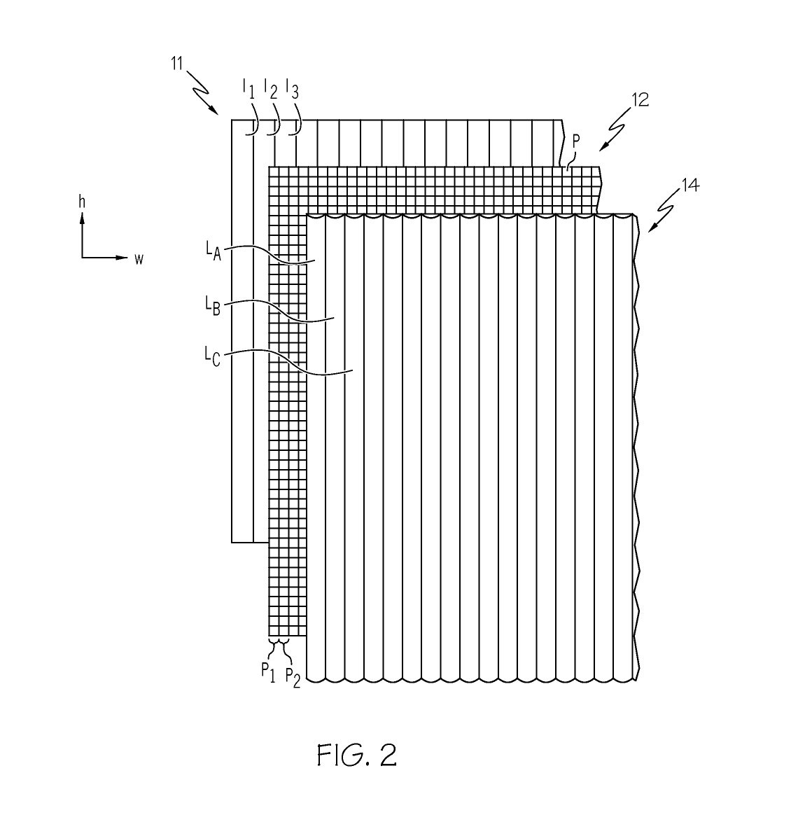

Referring now to FIGS. 1-3, operation of one particular type of a typical autostereoscopic display device 10 is schematically illustrated. It is noted that the autostereoscopic display device 10 schematically illustrated in FIGS. 1 and 2 represents only one particular way of producing three dimensional images autostereoscopically, and that many other technologies such as parallax barrier, directional backlights, and others may be used. All of these autostereoscopic display technologies present the same type of image defects and, therefore, the embodiments described herein may also be applied to those other autostereoscopic display technologies. Referring initially to FIG. 1, a schematic, top view illustration of an autostereoscopic display device 10 is provided. The autostereoscopic display device 10 includes a display panel 12 comprising an array of pixels and a lenticular lens assembly 14 comprising an array of lenses, such as cylindrical lenses, for example. An observer k located at a distance D from the autostereoscopic display device 10 sees two views produced by the autostereoscopic display device 10 at an observation plane 16 (e.g., view one V₁ by the left eye eₗ and view two V₂ by the right eye eᵣ).

The display panel 12 may be configured as a backlight liquid crystal display (LCD), for example. However, it should be understood that embodiments described herein may simulate autostereoscopic display devices that are based on display technologies other than LCD. A backlighting illumination source (not shown in FIG. 1) may emit light through the pixels of the display panel 12 such that a shadow of the pixels of the display panel 12 are incident on a back surface of the lenticular lens assembly 14. For example, the shadows of pixels P₁, P₂, and P₃ are incident on cylindrical lens L_{B} of the lenticular lens assembly. Each cylindrical lens of the lenticular lens assembly 14 has a number of pixels along width w associated therewith. In some autostereoscopic display devices, each cylindrical lens extends along a height h of the autostereoscopic display device such that each cylindrical lens is illuminated by several columns of pixels (see FIG. 2 for an illustration). Generally, each pixel or column of pixels provides a portion of a view of an image.

The lenticular lens assembly 14 is located in an optical path of the pixels such that pixels are imaged far from the autostereoscopic display device 10 at a distance D. Accordingly, the cylindrical lenses of the lenticular lens assembly 14 (e.g., cylindrical lenses L_{A}, L_{B}, and L_{C}) create a series of vertical bands at the level of the eye pupil within the observation plane 16. Each of these vertical bands corresponds to a particular “view” of the image (e.g., view V₁, view V₂ and view V₃). Such an autostereoscopic display device 10 is capable of creating a series of views that may be collected by the eyes of an observer and, therefore, create a three-dimensional impression.

FIG. 2 is a schematic, front-view illustration of an autostereoscopic display device 10. The autostereoscopic display device 10 has a display panel 12 having an array of pixels P, a lenticular lens assembly 14 having an array of cylindrical lenses (e.g., cylindrical lenses L_{A}, L_{B}, and L_{C}), and an illumination device 11. The illumination device 11 has an array of linear emitters (e.g., linear emitters I₁, I₂, and I₃, collectively “I”) that illuminate several pixels P along with width w of the display panel 12. Each column of pixels (e.g., P₁, P₂) represents a portion of a particular view created by the autostereoscopic display device 10. The linear emitters I of the illumination device may be configured using any number of linear illumination technologies, such as by linearly-arranged light emitting diodes (LED), xenon flash lamps, fluorescent tubes, and the like. As described below, embodiments of the present disclosure may simulate autostereoscopic display devices having several illumination configurations.

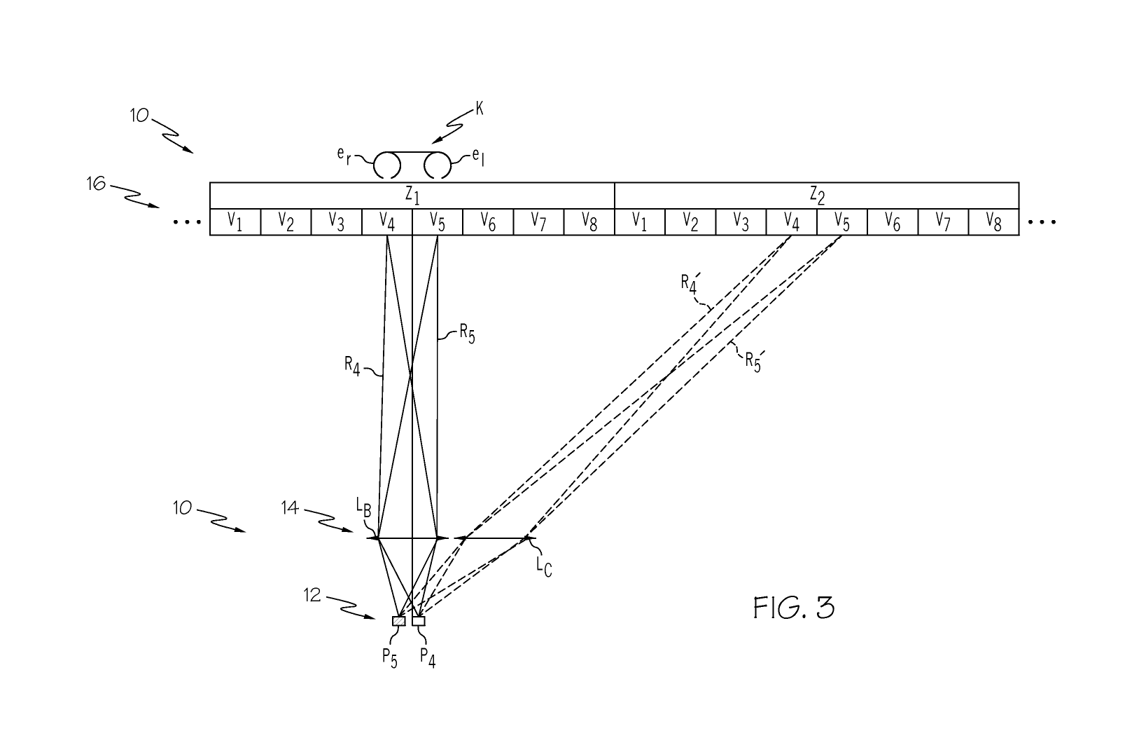

As described above, autostereoscopic display devices may generally produce many different views of a scene or object. Each view may be associated with viewing the scene or object from a particular angular position θk(t), where t is time. For example an observer may walk from a left-most view of the scene produced by the autostereoscopic display device toward a right-most view such that the observer may “look around” objects within the scene. FIG. 3 schematically depicts a top view of an autostereoscopic display device 10 that produces a plurality of zones defining multiple views. The autostereoscopic display device 10 has a display panel 12 and a lenticular lens assembly 14 as described above with reference to FIGS. 1 and 2. In the exemplary illustrated embodiment, each cylindrical lens of the lenticular lens assembly 14 has a diameter that is equal to eight times the size of the pixels of the display panel 12. For example, eight pixel columns are associated with cylindrical lens L_{B}. FIG. 3 shows only two piₓel columns P₄ and P₅ associated with cylᵢndricaₗ lens L_{B} for ease of illustration. The eight pixel columns of each cylindrical lens create zones that contain eight different views. It should be understood that embodiments of the present disclosure are capable of simulating an autostereoscopic display device having more or fewer views and zones than illustrated in FIG. 3.

For a given set of eight adjacent pixel columns, each zone is created by a given cylindrical lens of the array. Multiple zones are also created as the same set of pixel columns is imaged through multiple lenses. Referring to FIG. 3 as an illustrative example, two pixel columns P₄ and P₅ are depicted as being associated with cylindrical lens L_{B}. Pixel columns P₄ and P₅ are imaged by cylindrical lens L_{B} such that light ray R₄ associated with pixel column P₄ is received by the right eye eᵣ of an observer k as view V₄ of zone Z₁, and light ray R₅ associated pixel column P₅ is received by the left eye eₗ of the observer k as view V₅ zone Z₁. The autostereoscopic display device 10 is programmed such that view V₂ corresponds to the left view of view V₁, view V₃ is the left view of view V₂, and so on. Therefore, the observer k may change his or her angular position θk(t) within the viewing space to see different views of the image produced by the autostereoscopic display to look around objects in the image.

As shown in FIG. 3, the views produced by pixel columns P₁-P₈ of zone Z₁ are imaged by cylindrical lens L_{B} (as noted above, only pixel columns P₄ and P₅ are depicted in FIG. 3 for ease of illustration). Additionally, the views produced by pixel columns P₁-P₈ of zone Z₂ are imaged by cylindrical lens L_{C}. This is because the shadows of pixel columns P₁-P₈ are also received by cylindrical lens L_{C} and focused as light rays toward zone Z₂ (e.g., light rays R₄′ and R₅′ associated with pixel columns P₄ and P₅, respectively). It is noted that the pixel columns associated with cylindrical lens L_{C}, although not shown in FIG. 3, are also imaged by cylindrical lens L_{B} onto zone Z₁.

However, one issue with the autostereoscopic display device 10 producing multiple zones as shown in FIG. 3 is that, at the end of each zone, the last view (e.g., view V₈ of zone Z₁), which is supposed to be the most right view, is in contact with the first view of the next zone (e.g., view V₁ of zone Z₂). The consequence is that, if the observer is positioned between zones, the three-dimensional image will appear inverted (i.e., the right content is seen by the left eye and the left content is seen by the right eye), which may make for a disturbing impression.

To limit the occurrence of view inversion, one possible solution is to produce as many views as possible. As an example, in a dual-view device, the observer will be in an inversion location 50% of the time, while with a ten view device, the observer will be in an inversion location only 10% of the time. However, as views are added, image resolution decreases. One approach may be add more pixels to the display panel, which may be costly, and increasing pixel density by a factor of ten may not be reasonable.

Image inversion is one of many autostereoscopic image artifacts that are hardware related. Another autostereoscopic image artifact that may be present in a three-dimensional image produced by an autostereoscopic display device is the Moire effect. As described above, the three-dimensional effect is generated by creating an image of the display panel pixels in the plane of the observer's eyes. However, in reality, the pixels are always separated by a black area (also called the black matrix) which also gets imaged into the observer's eye plane. When the eye is positioned in the black areas, the image suddenly turns darker, which may give an undesirable impression. One way to avoid the Moire effect is to set the lenticular lens assembly at a certain angle with respect to the display panel, or to insert a diffusing element(s) into the optical path. However, this may lead to cross-talk, another autostereoscopic image artifact.

Cross-talk may occur when the cylindrical lenses do not make a perfect image of the pixels of the display panel. Rather, instead of creating well-separated views, the views can be superimposed for some locations of the observer. In that case, one single eye can collect multiple views, which may make the image look fuzzy in appearance. Generally, when display devices present cross-talk in the images, it may be necessary to limit the depth of the three-dimensional impression (i.e., image “pop”) to keep the image fuzziness to an acceptable degree. However, this may adversely affect the capability of the autostereoscopic display device to render impressive three-dimensional images, and may make the autostereoscopic display device produce three-dimensional images that are lower quality than those produced by other technologies, such as stereoscopic display devices that require observers to wear personal viewing devices (e.g., active or passive glasses).

View jump is an autostereoscopic image artifact that may be present when the observer is moving. As the observer moves, his or her eyes may move between views, and as a result, the observer may see abrupt jumps with the image suddenly changing content. When the autostereoscopic display device is optimized to produce a minimum of cross-talk, the views are well-separated and therefore view jumps may be the most visible. Where there is a significant amount of cross-talk, the image is made up of the sum of multiple views so that, instead of abruptly jumping from zone A to zone B, the observer will see a transition area made of the sum of both views. Therefore, autostereoscopic display devices with more cross-talk may produce less view jumps, but such displays may have either low resolution or very limited image pop.

Another autostereoscopic image artifact is due to the fact that the autostereoscopic display device may not always operate in an ideal, desired configuration. As an example, the observer may be at a viewing observation distance that is not ideal, or the cylindrical lenses may be slightly misaligned in angle with respect to the pixels, or the pitch of the lenses can also be slightly different from the ideal value. The consequence of all of these defects is generally that the view perceived by one eye of the observer can vary across the image. As an example, when the cylindrical lenses are slightly slanted with respect to the nominal value, the view perceived by one observer eye will vary in the vertical direction and the top of the image can be made of view A while the bottom may be made of view B (i.e., multi-view image). This type of defect may have some beneficial effect because rather than seeing abrupt view jumps, the view transition will move across the image and may give the impression of a wave passing through the image. However, this type of defect can also be negatively perceived, especially when the image presents a significant amount of image pop.

Autostereoscopic image artifacts may also be created by the algorithm(s) that generate the views displayed by the autostereoscopic display device. In general, these algorithms may be challenging since they require fabrication of real three-dimensional content from either two-dimensional content or from side by side three-dimensional content, such as the current image format used by polarization based display devices. To partly solve that problem, some specific image coding such as image plus depth have been created. However, there are still some challenging problems to solve. As an example, when an object A is popping out, the multi-view generation requires estimation of what is behind object A in order to generate the multiple views. To achieve this function, some algorithms look at scenes ahead of time so that they can deduce what is behind A by looking at images before A enters the scene. Further, these algorithms can help to improve image artifacts that are generated by the hardware. As an example, an eye tracker can look at the multiple observers' eyes and modify the image content based on the information of where the observers are located.

Based on the above, the design of autostereoscopic display devices that produce high-quality, three-dimensional images may be very challenging. The three-dimensional image that is produced is based on many software and hardware considerations. There are many associated autostereoscopic device parameters to consider, some of which are dependent on one another, such that when a design change is made to improve one autostereoscopic image artifact, another may be adversely affected. Accordingly, it may be very difficult to predict the general impression that will result from a given set of parameters, and it has been previously necessary to build a real system to determine if the global result is or is not acceptable from a general human perception point of view. However, building an autostereoscopic display device to test a set of image parameters may be very time consuming and costly.

Embodiments described herein enable users (e.g., autostereoscopic display designers, engineers, scientists, and the like.) to test, in real-time, any set of autostereoscopic device parameters of an autostereoscopic display device and immediately determine the impact of those parameters on how the resulting images are perceived by an observer. Embodiments simulate an autostereoscopic display device so that an actual testing device does not need to be built. Autostereoscopic device parameters may be based on any number of hardware and/or software considerations, such as pixel size, pixel pitch, illumination attributes, lens design, autostereoscopic image generation algorithms and the like. As described above, these autostereoscopic device parameters and their combinations result in autostereoscopic image artifacts.

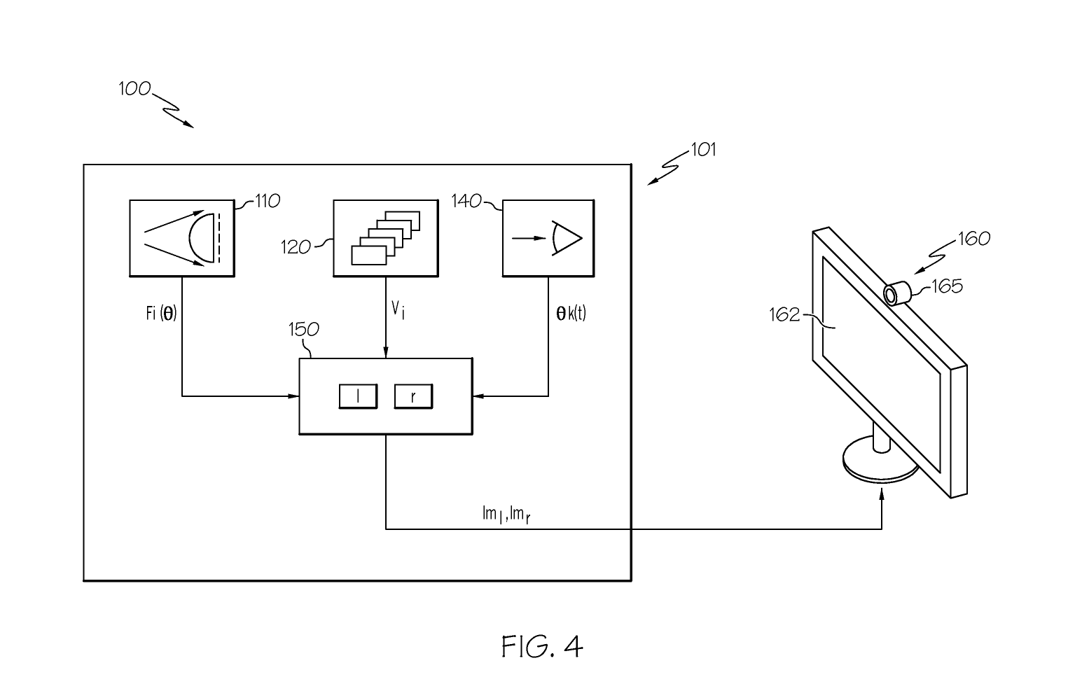

Referring now to FIG. 4, an exemplary display apparatus 100 and method for simulating an autostereoscopic display device is schematically illustrated. The exemplary display apparatus 100 generally comprises an image-generation unit 101 that is communicatively coupled to a stereoscopic display device 160. Generally, the image-generation unit 101 is configured to generate a view pair that is sent to the stereoscopic display device 160, wherein the view pair is based on a plurality of autostereoscopic device parameters. The images sent to the stereoscopic display device 160 are generated such that artifacts that should be seen in an actual autostereoscopic display device are added to the image content and produced on the stereoscopic display device 160. The image-generation unit 101 may be communicatively coupled to the stereoscopic display device 160 by any coupling method, such as by wireless or wired communication.

In one embodiment, the image-generation unit 101 is a unit that is separate from the stereoscopic display device 160. In another embodiment, the image-generation unit 101 is integrated into the stereoscopic display device 160 such that it is an integral component of the stereoscopic display device 160 (i.e., maintained within the housing of the stereoscopic display device 160).

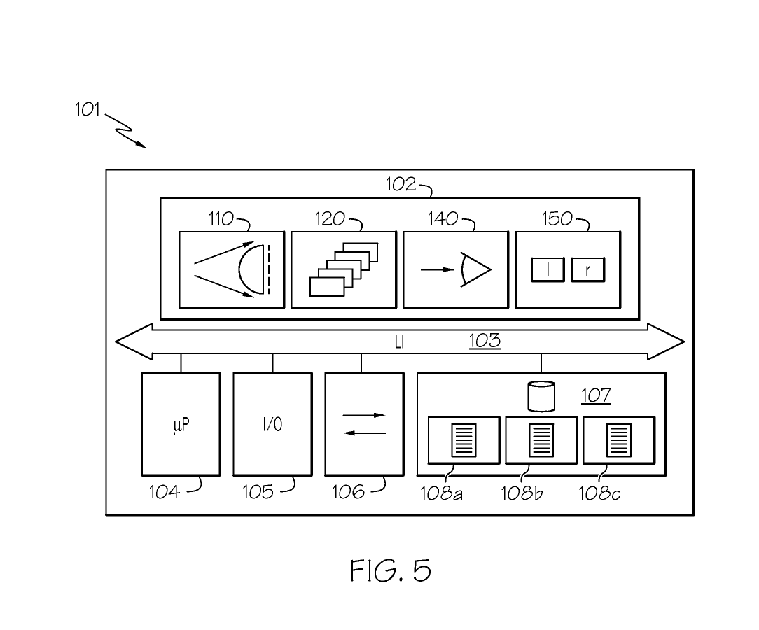

FIG. 5 illustrates internal components of an image-generation unit 101 as described above, further illustrating a display apparatus for generating view pairs for simulating an autostereoscopic display device using a stereoscopic display device, and/or a non-transitory computer-readable medium for generating view pairs as hardware, software, and/or firmware, according to embodiments shown and described herein. While in some embodiments, the image-generation unit 101 may be configured as a general purpose computer with the requisite hardware, software, and/or firmware, in some embodiments, the image-generation unit 101 may be configured as a special purpose computer designed specifically for performing the functionality described herein.

As also illustrated in FIG. 5, the image-generation unit 101 includes a processor 104, input/output hardware 105, network interface hardware 106, a data storage component 107 (which stores various autostereoscopic image parameter data sets 108a, 108b, 108c), and a non-transitory memory component 102. The memory component 102 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. Additionally, the memory component 102 may be configured to store computer-executable instructions associated with the pixel intensity module 110, the view generator module 120, the eye tracking module 140, and the view pair generation module 150 (each of which may be embodied as a computer program, firmware, or hardware, as an example). A local interface 103 is also included in FIG. 5 and may be implemented as a bus or other interface to facilitate communication among the components of the image-generation unit 101.

The processor 104 may include any processing component configured to receive and execute instructions (such as from the data storage component 107 and/or memory component 102). The processor 104 may comprise one or more general purpose processors, and/or one or more application-specific integrated circuits. The input/output hardware 105 may include a monitor, keyboard, mouse, printer, camera (e.g., for use by the eye tracking module 140, as described below), microphone, speaker, touch-screen, and/or other device for receiving, sending, and/or presenting data. The input/output hardware 105 may be used to input the autostereoscopic device parameters, for example. The network interface hardware 106 may include any wired or wireless networking hardware, such as a modem, LAN port, wireless fidelity (Wi-Fi) card, WiMax card, mobile communications hardware, and/or other hardware for communicating with other networks and/or devices, in embodiments that communicate with other hardware (e.g., remote configuration of the image-generation unit 101). It is noted that the image-generation unit 101 may communicate to display drivers of the stereoscopic display device 160 by a signal output module, which may be provided by the input/output hardware, such as a video input/output port, or by the network interface hardware 106, such as via a wireless communications channel.

It should be understood that the data storage component 107 may reside local to and/or remote from the image-generation unit 101 and may be configured to store one or more pieces of data for access by the image-generation unit 101 and/or other components. As illustrated in FIG. 5, the data storage component 107 may store data sets 108a, 108b, 108c corresponding to various parameters, data, algorithms, etc. used to generate the view pairs. Any data may be stored in the data storage component 107 to provide support for functionalities described herein.

Included in the memory component 102 are computer-executable instructions associated with the pixel intensity module 110, the view generator module 120, the eye tracking module 140, and the view pair generation module 150. Operating logic may be included to provide for an operating system and/or other software for managing components of the image-generation unit 101. The computer-executable instructions may be configured to perform the autostereoscopic display device simulation functionalities described herein.

It should be understood that the components illustrated in FIG. 5 are merely exemplary and are not intended to limit the scope of this disclosure. More specifically, while the components in FIG. 5 are illustrated as residing within the image-generation unit 101, this is a nonlimiting example. In some embodiments, one or more of the components may reside external to the image-generation unit 101.

Referring once again to FIG. 4, the stereoscopic display device 160 may be any three-dimensional display device that is substantially inherently free from the autostereoscopic image artifacts described above so that any image artifacts that are displayed by the stereoscopic display device 160 are attributed to the images produced by the image-generation unit 101 and not the stereoscopic display device 160 itself. In other words, the stereoscopic display device should be capable of producing a high-quality, three-dimensional image that may be used as a baseline in evaluating the image pairs generated by the image-generation unit 101. The stereoscopic display device 160 may produce some image artifacts so long as an observer may be able to discern the difference between the image artifacts of the stereoscopic display device 160 and the autostereoscopic display artifacts produced by the image-generation unit 101. Specifically, the stereoscopic display device 160 should be substantially free from at least Moire effect, view cross-talk, view jump, and multi-view images.

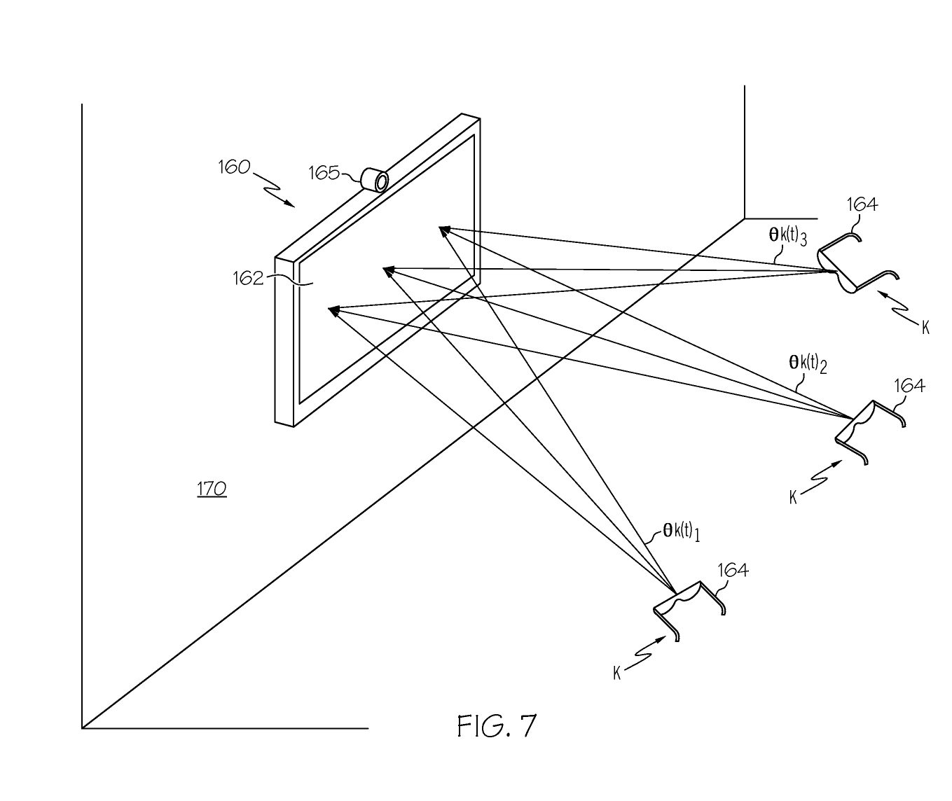

The stereoscopic display device 160 generally comprises a display screen 162 from which three-dimensional content is provided, and, in some embodiments, an eye-tracking device 165 for tracking an angular position of an observer(s) viewing the stereoscopic display device 160. The stereoscopic display device 160 may further comprise a personal viewing device 164 for use by the observer (see FIG. 7). In one embodiment, the personal viewing device 164 may be configured as an active device, such as active shutter glasses that rapidly turn on and off in synchronization with left and right images displayed by the stereoscopic display device 160. In another embodiment, the personal viewing device 164 may be configured as passive glasses that are polarized such that only an individual right eye image produced by the stereoscopic display device 160 reaches the right eye, and only an individual left eye image reaches the left eye (i.e., a passive device).

Still referring to FIG. 4, the image-generation unit 101 generally comprises a pixel intensity module 110, a view generator module 120, an eye tracking module 140, and a view pair generation module 150. Alternative embodiments may include fewer modules than those depicted in FIG. 4. As an example and not a limitation, in one embodiment, the image-generation unit 101 may only include a pixel intensity module 110, a view generator module 120, and a view pair generation module 150. However, other configurations are contemplated.

Generally, the view pair generation module 150 receives the outputs from the other modules as input and creates a right eye image and a left eye image (i.e., a view pair) that is then sent to the stereoscopic display device 160. As described in detail below, the view pair corresponds with a three-dimensional image that would have been seen by an observer k located at a particular location θk had the observer been viewing an actual autostereoscopic display device. For example, the location of the observer may dictate which view of which zone the viewer would see, as described above with reference to FIG. 3.

Generally, the pixel intensity module 110 produces an influence function Fi(θ) that corresponds to the relative intensity seen from pixel i that corresponds to view i by an observer located at an angle θ (i.e., the relative intensity of individual pixels of the various views). The view generator module 120 creates a plurality of views that may be sent to the stereoscopic display device (e.g., the views depicted in FIG. 3), and the eye tracking module 140 tracks, in real time, the position θk(t) of a given observer (e.g., by an eye-tracking device 165 such as a camera). The view pair generation module 150 receives the various inputs and creates a view pair that corresponds to left and right images that are sent to the stereoscopic display device 160 and seen by the observer. Each of the modules of the image-generation unit 101 will now be described in turn with specificity.

The pixel intensity module 110 provides an influence function that influences the light emitted by one or more pixels of the stereoscopic display device 160. In one embodiment, the influence function comprises a pixel intensity function Fi(θ) that corresponds to a relative intensity of pixels of the image as seen by an observer at different angular positions θk. In one embodiment, the pixel intensity function Fi(θ) is configured as a matrix or a look-up table. As described above, the views seen by an observer k of an autostereoscopic display device depends on the location of the observer k in the observation plane. The relative intensity of the pixels seen by the observer k may change between angular positions. The pixel intensity module 110 calculates or otherwise determines, for a given angular position of an observer k, how much optical power is seen from each pixel.

In one embodiment, a ray tracing model of the cylindrical lenses of a computer-modeled lenticular lens assembly under evaluation may be used to determine the pixel intensity function Fi(θ) for a plurality of pixels corresponding to a plurality of views for a plurality of angular locations θk. Although the ray tracing model described herein is generated by a computer simulation model, embodiments are not limited thereto. The modeled lenticular lens assembly may be a hypothetical lenticular lens assembly that is under development, or a computer model of an actual lenticular lens assembly that has been physically built.

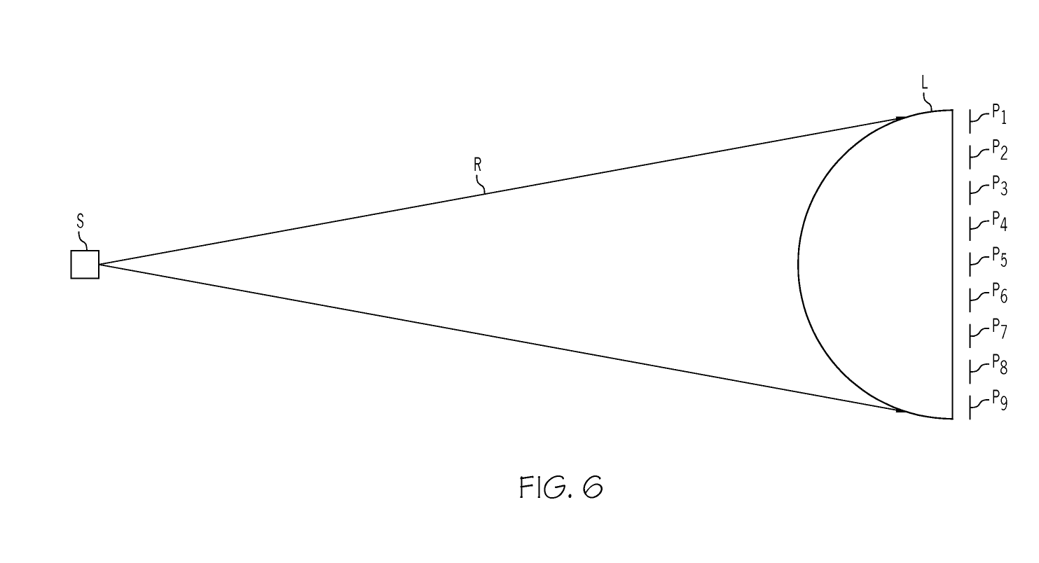

Referring to FIG. 6, the computer ray tracing model considers a light source S at an observation distance from the cylindrical lens L that emits a bundle of light rays R from an aperture that is substantially equal to the average diameter of a pupil of the average human eye. The model may consider many optical parameters, such as, but not limited to, index of refraction, reflectivity, and the like. The bundle of light rays R is such that it covers an entire diameter of one of the cylindrical lenses L of the lenticular lens assembly under evaluation. The location of the rays imaged on each of the pixels (e.g., pixels P₁-P₉) is determined, as well as the percentage of the bundle of light rays that is incident on each individual pixel of each view. The process may then be repeated for multiple positions of the observer (i.e., angular location θk), and, in one embodiment, the results saved as a matrix, where each line corresponds to the percentage of light that corresponds to specific views.

As an example and not a limitation, consider that an autostereoscopic display device under evaluation has nine views and assume that, for a given observer position, 20% of the optical power of the light ray passing through the cylindrical lens is incident on a pixel of view V₃ (e.g., pixel P₃ of FIG. 6), 60% is incident on view V₄ (e.g., pixel P₄), and 20% is incident on the black matrix between pixels. In this example, the corresponding line of the pixel intensity function Fi(θ) of the matrix may read:

0|0|0.2|0.6|0|0|0|0|0

The output Fi(θ) may be provided to the view pair generation module 150 to generate the view pairs sent to the stereoscopic display device 160. Accordingly, the pixels of the view pairs that are generated by the view pair generation module 150 may have the relative intensity values as provided by the pixel intensity function Fi(θ).

A user may then create different lenticular lens assembly models having different configurations, and use the display apparatus 100 to simulate the images resulting from such configurations. For example, a user, such as a designer, may change the diameter of the cylindrical lenses, change the material (and therefore optical parameters such as index of refraction), increase or decrease the number or size of the pixels, and the like. The resulting pixel intensity function Fi(θ) may then be provided to the view pair generation module 150 for testing.

Referring once again to FIG. 4, the view generator module 120 generates the multiple views corresponding to images that are sent to the pixels of the simulated autostereoscopic display. Any number of views may be generated. As an example and not a limitation, eight views may be generated as is illustrated in FIG. 3. The view generator module 120 may generate the multiple views using any known or yet-to-be-developed multi-view generation technique. In one embodiment, the views are generated by a synthetic image wherein the position in space of the objects to be displayed on the simulated autostereoscopic display is known. Each view may then be calculated using geometric rules.

In another embodiment, a real-time multi-view generation algorithm(s) may be used to create the multiple views. As an example and not a limitation, multi-view generation algorithms created by 3D Fusion of New York, N.Y., may be use to create the views. In embodiments that use real-time multi-view generation algorithms, specialized hardware may be needed to process the amount of read-time data that is needed. For example, the view generator module 120 according to one embodiment may comprise one or more application-specific integrated circuits to process the real-time data and generate the multiple views.

In another embodiment, multiple cameras set such that the distance between each camera is equivalent to a human eye distance (about 60 mm) may be used to image objects of a scene. The images may be acquired in real time with moving objects, or single images may be acquired once and saved in a memory location.

The output of the view generator module 120 is a series of images, Vᵢ, with each image corresponding to the content displayed in view i. The series of images Vᵢ, may be sent to the view pair generation module 150 for retrieval. As described in more detail below, the view pair generation module 150 may select the appropriate views created by the view generator module 120 depending on a location of the observer. For example, if a designer wishes to simulate views four and five of zone one, the view pair generation module 150 will access views four V₄ and five V₅ of zone one Z₁ of a scene as provided by the view generator module 120.

The eye tracking module 140 tracks in real-time the position θk(t) of an observer k over time (t). The position θk(t) may take into account an actual location of the observer k as well as the direction of the observer's eyes. The eye tracking module 140 may be configured in a variety of ways. In one embodiment, the eye tracking module 140 is configured as a wearable device, such as the personal viewing device used to view the stereoscopic display device 160. As an example and not a limitation, the eye tracking module 140 may comprise the Kinect™ eye tracking glasses made by Microsoft® Corporation.

In another embodiment, the eye tracking module 140 comprises a camera, such as the camera depicted in FIG. 4. The eye tracking module 140 of this embodiment may optionally include a wearable light source that the camera may track. Images may be acquired in real-time, and the position of the observer k may be calculated as the centroid of the threshold image. In one embodiment, multiple cameras and multiple light sources of different colors may be used to track multiple observers at the same time. Additionally, because the angular field of view of the camera may be limited, multiple cameras may be utilized. The multiple cameras may view the observer field from different angles. The field of view of each camera may be calibrated to avoid artificial image jumps when the observer(s) moves from one camera to the next.

FIG. 7 depicts a stereoscopic display device 160 that is mounted on a wall 170, and multiple positions of an observer k over time (t) within an observation field. The observer k is illustrated as wearing a personal viewing device 164. In the illustration, the observer k is viewing the stereoscopic display device at a first angular position θk(t)₁ at a first time. The angular position θk(t) may vary within a range as the observer k moves his or her eyes back and forth to view all portions of the display screen 162. The observer k may then move to a second angular position θk(t)₂ at a second time, and then a third angular position θk(t)₃ at a third time. It should be understood that FIG. 7 is provided for illustrative purposes only, and embodiments are not limited to any observing position or duration. As the observer k moves throughout the observation field, a different angular position θk(t) is determined, and influences which views the observer will see. The angular position θk(t) produced by the eye tracking module 140 is provided to the view pair generation module 150.

Referring once again to FIG. 4, the view pair generation module 150 receives the data from the above-described modules to calculate or otherwise generate the left and right images that are to be sent to the stereoscopic display device 160. More specifically, the view pair generation module 150 may use the outputs of the pixel intensity module 110, the view generator module 120, and the eye tracking module 140 to generate a left eye image Imₗ and a right eye image Imᵣ that would be seen by a given observer located at a given angular position θk(t) as determined by the eye tracking module 140. For example, for a given angular position θk(t), the view pair generation module 150 may select a first view and a second view of the plurality of views generated by the view generator module 120.

The view pair generation module 150 may use any formula to calculate the left eye image Imₗ and the right eye image Imᵣ. In one embodiment, the left eye image Imₗ and the right eye image Imᵣ are determined by:

$$\begin{matrix}{Im}_{l} = {\sum }_{i} Fi ( θ k ( t ) - \frac{Δ}{2} ) * Vi ; and & Eq . ( 1 ) \\ {Im}_{r} = {\sum }_{i} Fi ( θ k ( t ) + \frac{Δ}{2} ) * Vi , & Eq . ( 2 )\end{matrix}$$

where:

Imₗ is the left eye image;

Imᵣ is the right eye image;

Vi is a view of a plurality of views; and

Δ is an inter eye angular distance of the observer.

Embodiments are not limited to Equations (1) and (2) above, nor Equations (3) and (4) below. Embodiments may also consider other features, such as gamma correction factors that take into account the grey level non-linearity of conventional display screens. As an example and not a limitation, the gamma factor is usually set to 2.2 but may require calibration if the stereoscopic display device 160 presents some non-linearity.

The resulting left eye image Imₗ and right eye image Imᵣ that is displayed by the stereoscopic display device 160 will exhibit some of the autostereoscopic image artifacts based on the autostereoscopic device parameters inputted into the image generation unit. For example, the pixel intensity function Fi(θ) may be based on hardware considerations such as lenticular lens assembly design and pixel arrangement, among many others. Such autostereoscopic device parameters are accounted for in the pixel intensity function Fi(θ) and, because the view pair generation module 150 utilizes the pixel intensity function Fi(θ) in its calculation of the view pair, autostereoscopic image artifacts associated with the autostereoscopic device parameters will be present in the resulting images displayed by the stereoscopic display device 160. As an example and not a limitation, if a particular lenticular lens assembly and display panel leads to a significant amount of light reaching adjacent pixels of the display, significant cross-talk may be present in the left eye image Imₗ and the right eye image Imᵣ images displayed by the stereoscopic display device 160. Further, multi-zone artifacts may be viewed by an observer by walking to an angular position k(θ) that yields a resulting image that is between adjacent zones. Other image artifacts including those described above (as well as others) may be visible in the resulting left eye image Imₗ and right eye image Imᵣ.

When applying Equations (1) and (2), the same set of views will be applied to the entire image. In order to take into account other image artifacts, such as multi-view images, some additional factors may be taken into consideration, such as those provided by:

$$\begin{matrix}{Im}_{l} = {\sum }_{i} Fi ( θ k ( t ) - \frac{Δ}{2} - Ω ( x , y ) ) * Vi ( x , y ) ; and & Eq . ( 3 ) \\ {Im}_{r} = {\sum }_{i} Fi ( θ k ( t ) + \frac{Δ}{2} - Ω ( x , y ) ) * Vi ( x , y ) , & Eq . ( 4 )\end{matrix}$$

where:

Imₗ is the left eye image;

Imᵣ is the right eye image;

Vi is a view of a plurality of views;

Δ is an inter eye angular distance of the observer; and

Ω(x,y) is a view shift that varies across image-coordinates (x,y) of the view.

Accordingly, Equations (3) and (4) take into consideration image coordinates on the display screen 162. For example, autostereoscopic image artifacts such as cross-talk and Moire effect may be different on a top part of the image from the bottom part of the image.

The data representing the left and right eye images Imₗ, Imᵣ is converted into a format that is readable/executable by the stereoscopic display device 160. The stereoscopic display device 160 receives the data representing the left and right eye images Imₗ, Imᵣ and displays the respective images on the display screen 162 to be viewed by an observer. As described above, a user may input various parameters into the image-generation unit 101 to test any number of autostereoscopic image parameter combinations without having to build an actual auto stereo scopic display.

The view pair generation module 150 may be programmed to calculate and provide the view pairs dynamically in real-time as the observer views the stereoscopic display device 160 and moves within the observation plane. Alternatively, the view pairs for various angular positions θk(t) may be calculated off-line and stored in a memory location for access by the view pair generation module 150 while the observer is viewing the stereoscopic display device 160.

Referring once again to FIG. 7, embodiments of the present disclosure enable qualitative assessment of autostereoscopic device parameters associated with particular hardware and/or software considerations. As an example and not a limitation, a first combination of autostereoscopic device parameters may be provided to the image generation unit 101, and an observer k may observe view pairs on the stereoscopic display device 160 in the observation plane. The observer k may move to various angular positions θk(t) over time while observing the various autostereoscopic image defects that are included in view pairs that are displayed. Next, a second combination of autostereoscopic device parameters may be provided to the image generation unit 101 so that the observer k may view the view pairs associated with the second combination and compare them to the view pairs associated with the first combination of autostereoscopic device parameters. The process may be repeated until satisfactory autostereoscopic device parameters are determined.

The modules described above may be implemented as hardware, software, or combinations thereof. Although FIG. 4 illustrates the various modules of the image-generation unit 101 as being included in a single device, embodiments are not limited thereto. For example, each module may be configured as an individual device, wherein the devices are coupled to the view pair generation module 150. In one embodiment, each of the modules are implemented as software within a computer device, such as a general purpose computer. In another embodiment, one or more of the modules depicted in FIG. 4 are implemented as a specialized computer device.

Based on the foregoing, it should now be understood that embodiments of the present disclosure may enable the simulation of autostereoscopic display devices to test autostereoscopic device parameters without requiring expensive and time consuming hardware to be built and evaluated. Users, such as designers of autostereoscopic display devices, may input autostereoscopic device parameters into an image-generation unit that produces a view pair comprising a left eye image and a right eye image that is provided to a stereoscopic display, which displays the view pair. The view pair includes autostereoscopic image artifacts that are based on the autostereoscopic device parameters inputted into the image-generation unit. Designers may iteratively change the autostereoscopic device parameters and quickly view the image response. Further, designers may use computer modeling to develop components of an autostereoscopic display device, and input autostereoscopic display parameters associated with the computer-generated models into the image-generation unit for a streamlined design process.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A display apparatus for simulating an autostereoscopic display device, the display apparatus comprising:
a stereoscopic display capable of displaying a three-dimensional image that is inherently substantially free from image artifacts; and
an image-generation unit for providing data representing at least one view pair to the stereoscopic display, the at least one view pair comprising a right eye image for viewing on the stereoscopic display by a right eye of an observer k, and a left eye image for viewing on the stereoscopic display by a left eye of the observer k, the at least one view pair based at least in part on autostereoscopic device parameters that introduce autostereoscopic image artifacts such that the stereoscopic display displays the at least one view pair having the autostereoscopic image artifacts.

2. The display apparatus of claim 1, wherein the image-generation unit comprises at least one of:
a pixel intensity module providing at least one pixel intensity function Fi(θ) corresponding to individual pixels of the left eye image and the right eye image;
a view generator module generating a number of views to be sent to the stereoscopic display, wherein each view represents an individual right eye image or an individual left eye image depending on a location of the observer; and
an eye tracking module determining an angular position θk(t) of the observer k over time (t).

3. The display apparatus of claim 1, wherein the image-generation unit comprises a pixel intensity module calculating a pixel intensity function Fi(θ) corresponding to a relative intensity of pixel i of the right eye image and a relative intensity of pixel i of the left eye image seen by the observer k located at an angle θ with respect to the stereoscopic display, wherein Fi(θ) is based at least in part on an angular position of the observer k with respect to the stereoscopic display.

4. The display apparatus of claim 1, wherein the image-generation unit comprises a view generator module that generates more than two views to be sent to the stereoscopic display, wherein each view represents an individual right eye image or an individual left eye image, and the views displayed by the stereoscopic display depend on a location of the observer k.

5. The display apparatus of claim 1, wherein the image-generation unit comprises:
a pixel intensity module calculating at least one pixel intensity function Fi(θ) corresponding to individual pixels of the left eye image and the right eye image;
a view generator module generating a number of views to be sent to the stereoscopic display, wherein each view represents an individual right eye image or an individual left eye image depending on a location of the observer;
an eye tracking module determining an angular position θk(t) of the observer k over time (t); and
a view pair generation module receiving input from the pixel intensity module, the view generator module, and the eye tracking module to generate the right eye image and the left eye image of the at least one view pair.

6. The display apparatus of claim 5, wherein the view pair generation module calculates the right eye image and the left eye image such that:
$${Im}_{l} = {\sum }_{i} Fi ( θ k ( t ) - \frac{Δ}{2} ) * Vi ; and$$
$${Im}_{r} = {\sum }_{i} Fi ( θ k ( t ) + \frac{Δ}{2} ) * Vi ,$$
where:
Imₗ is the left eye image;
Imᵣ is the right eye image;
Vi is a view of a plurality of views; and
Δ is an inter eye angular distance of the observer.

7. The display apparatus of claim 5, wherein the view pair generation module calculates the right eye image and the left eye image such that:
$${Im}_{l} = {\sum }_{i} Fi ( θ k ( t ) - \frac{Δ}{2} - Ω ( x , y ) ) * Vi ( x , y ) ; and$$
$${Im}_{r} = {\sum }_{i} Fi ( θ k ( t ) + \frac{Δ}{2} - Ω ( x , y ) ) * Vi ( x , y ) ,$$
where:
Imₗ is the left eye image;
Imᵣ is the right eye image;
Vi is a view of a plurality of views;
Δ is an inter eye angular distance of the observer k; and
Ω(x,y) is a view shift that varies across image-coordinates (x,y) of the view.

8. A method of simulating an autostereoscopic display device, the method comprising:
generating or receiving a plurality of views of an image;
determining an angular position θk(t) of an observer k over time (t) based on a location of the observer;
generating a view pair comprising a right eye image and a left eye image by applying an influence function to both a first view of the plurality of views and a second view of the plurality of views, the influence function based at least in part on autostereoscopic device parameters and the angular position θk(t) of the observer k, wherein the autostereoscopic device parameters introduce autostereoscopic image artifacts into the view pair;
providing data representing the view pair to a stereoscopic display that is inherently substantially free from image-artifacts; and
displaying the view pair on the stereoscopic display.

9. The method of claim 8, wherein the autostereoscopic image artifacts comprise at least one of: Moire effect, view cross-talk, view jump, and multi-view image.

10. The method of claim 8, wherein:
the right eye image and the left eye image each comprise a plurality of pixels displayed by the stereoscopic display; and
the autostereoscopic device parameters comprise at least one of: relative intensity of individual pixels of the plurality of pixels, inter angular eye distance, number of views, view position θk(t) of the observer k over time (t), and view shift.

11. The method of claim 8, further comprising:
generating a plurality of view pairs; and
storing the plurality of view pairs for subsequent display on the stereoscopic display.

12. The method of claim 8, wherein the influence function is based at least in part on a pixel intensity function Fi(θ) corresponding to individual pixels of the right eye image and the left eye image.

13. The method of claim 12, wherein the pixel intensity function Fi(θ) is determined by:
using a computer simulation model, propagating a bundle of light rays from a source toward an individual lens of a modeled lenticular lens assembly comprising an array of lenses, wherein a diameter of the source is approximately equal to a diameter of an average human eye at a position θ, and the bundle of light rays is such that it is incident on an entire diameter of the individual lens; and
determining a percentage of the bundle of light rays that is incident on each pixel associated with the individual lens.

14. The method of claim 8, wherein the view pair is generated such that:
$${Im}_{l} = {\sum }_{i} Fi ( θ k ( t ) - \frac{Δ}{2} ) * Vi ; and$$
$${Im}_{r} = {\sum }_{i} Fi ( θ k ( t ) + \frac{Δ}{2} ) * Vi ,$$
where:
Imₗ is the left eye image;
Imᵣ is the right eye image;
Vi is a view of the plurality of views; and
Δ is an inter eye angular distance of the observer k.

15. The method of claim 8, wherein the view pair is generated such that:
$${Im}_{l} = {\sum }_{i} Fi ( θ k ( t ) - \frac{Δ}{2} - Ω ( x , y ) ) * Vi ( x , y ) ; and$$
$${Im}_{r} = {\sum }_{i} Fi ( θ k ( t ) + \frac{Δ}{2} - Ω ( x , y ) ) * Vi ( x , y ) ,$$
where:
Imₗ is the left eye image;
Imᵣ is the right eye image;
Vi is a view of the plurality of views;
Δ is an inter eye angular distance of the observer; and
Ω(x,y) is a view shift that varies across image-coordinates (x,y) of the view.

16. A display apparatus for simulating an autostereoscopic display device, the display apparatus comprising:
a stereoscopic display capable of displaying a three-dimensional image that is inherently substantially free from image artifacts;
an image-generation unit comprising a processor, a signal output module, and a memory component, the memory component storing computer-executable instructions that, when executed by the processor, cause the image-generation unit to:
generate or receive a plurality of views of an image;
determine an angular position θk(t) of an observer k over time (t) based on a location of the observer;
generate a view pair comprising a right eye image and a left eye image by applying an influence function to both a first view of the plurality of views and a second view of the plurality of views, the influence function based at least in part on autostereoscopic device parameters and the angular position θk(t) of the observer k, wherein the autostereoscopic device parameters introduce autostereoscopic image artifacts into the view pair; and
provide data representing the view pair to the stereoscopic display via the signal output module, wherein the stereoscopic display displays the view pair having the autostereoscopic image artifacts.

17. The display apparatus of claim 16, wherein the autostereoscopic image artifacts comprise at least one of: Moire effect, view cross-talk, view jump, and multi-view image.

18. The display apparatus of claim 16, wherein:
the image-generation unit generates a plurality of views; and
each individual view of the plurality of views corresponds to an individual right eye image or an individual left eye image.

19. The display apparatus of claim 16, further comprising a personal viewing device for use by the observer k of the stereoscopic display.

20. The display apparatus of claim 16, wherein:
the right eye image and the left eye image each comprise a plurality of pixels that are displayed by the stereoscopic display; and
the autostereoscopic device parameters comprise at least one of: relative intensity of individual pixels of the plurality of pixels, inter angular eye distance, number of views, angular position θk(t) of the observer k over time (t), and view shift.
